(19) United States
(12) Patent Application Publication
(10) Pub. No.: US 2014/0112102 A1
(43) Pub. Date: Apr. 24, 2014

(54) INTENTIONAL ALIASING OF ULTRASOUND TO DOWNCONVERT TO AUDIO TONES

(71) Applicant: SYMBOL TECHNOLOGIES, INC., Schaumburg, IL (US)

(72) Inventor: Russell E. Calvarese, Stony Brook, NY (US)

(73) Assignee: Symbol Technologies, Inc., Schaumburg, IL (US)

(21) Appl. No.: 13/654,599

(22) Filed: Oct. 18, 2012

(51) Int. Cl. G01S 3/80

(52) U.S. Cl. 367/118

(57) ABSTRACT

A method and device for aliasing ultrasound to produce audio tones includes a microphone circuit to receive an ultrasonic burst from at least one emitter in an environment. An analog-to-digital converter can convert the ultrasonic burst into a digital waveform. A digital signal processor can: provide an ultrasonic sampling frequency, alias the digital waveform with the ultrasonic sampling frequency to provide an audio signal, and detect the audio signal frequency. An amplitude of multiple audio signals can be used to locate the device within the environment.

### FIELD OF THE DISCLOSURE

The present disclosure relates generally to an ultrasonic system, and more particularly to aliasing of ultrasound to produce audio tones.

### BACKGROUND

An ultrasonic receiver can be used to determine a location of that receiver with reference to an ultrasonic emitter, such as locating a mobile device having an ultrasonic receiver and being present within a retail, factory, warehouse, or other indoor environment, for example, that includes fixed ultrasonic emitters. The ultrasonic emitter can transmit ultrasonic energy in a short burst which can be received by an ultrasonic transducer (microphone) in the ultrasonic receiver, thereby establishing at least the presence of the device within the environment without being audible to users within the environment.

Further, the use of several ultrasonic emitters distributed within the environment can also be used to establish not only the presence but also a specific location of a particular device using techniques known in the art such as hyperbolic positioning, triangulation, trilateration, and the like, as have been used in radio frequency locationing systems.

Mobile devices such as smart phones already include audio microphone and receiver circuitry that has usable response into ultrasonic frequencies, i.e. 22.05 kHz. Therefore, a mobile device could be configured to detect and analyze ultrasonic signals from emitters within the environment to determine it s location. This can be accomplished using digital signal processing within the mobile device to analyze the signals from the various emitters. However, it can be a problem to analyze signals at the very high end of the audio circuitry's capability of the mobile device. Not only does response fall off at high frequencies, digital signal processing of these frequencies places more demand on the processor. An additional problem analyzing these frequencies occurs when the operating systems and/or audio hardware drivers of the mobile device do not support the required digital signal processing functions or otherwise provide access to needed signal buffers by an application level software component. This applies when it is not possible or practical for an application level programmer to require modifications to the operating system and/or audio hardware drivers.

Accordingly, there is a need for a technique to improve the processing of ultrasonic frequencies within an indoor environment without the modification of existing phone hardware.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of an ultrasonic aliasing system, in accordance with the present invention.

FIG. 2 is a flow diagram illustrating a method for ultrasonic aliasing, in accordance with the present invention.

FIG. 3 is a graphical representation of Doppler locationing, in accordance with one embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, a technique is described to improve the processing of ultrasonic frequencies produced within an indoor environment without modification of existing phone hardware. In particular, the present invention uses intentional aliasing of ultrasonic signals in a mobile device to provide audio tones that can be easily processed by the mobile device. It is envisioned that the present invention can be implemented by a custom application that is downloaded to a smart phone and is usable in an environment with pre-disposed ultrasonic emitters dispersed therein.

The mobile device described herein can include a wide variety of business and consumer electronic platforms such as cellular radio telephones, mobile stations, mobile units, mobile nodes, user equipment, subscriber equipment, subscriber stations, mobile computers, access terminals, remote terminals, terminal equipment, cordless handsets, gaming devices, smart phones, personal computers, and personal digital assistants, and the like, all referred to herein as a device. Each device comprises a processor that can be further coupled to a keypad, a speaker, a microphone, a display, signal processors, and other features, as are known in the art and therefore not shown or described in detail for the sake of brevity.

Various entities are adapted to support the inventive concepts of the embodiments of the present invention. Those skilled in the art will recognize that the drawings herein do not depict all of the equipment necessary for system to operate but only those system components and logical entities particularly relevant to the description of embodiments herein. For example, routers, controllers, switches, access points/ports, and wireless clients can all includes separate communication interfaces, transceivers, memories, and the like, all under control of a processor. In general, components such as processors, transceivers, memories, and interfaces are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement one or more processors that perform the given logic. Therefore, the entities shown represent a system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the memory and control aspects of the present invention may be implemented in any of the devices listed above or distributed across such components.

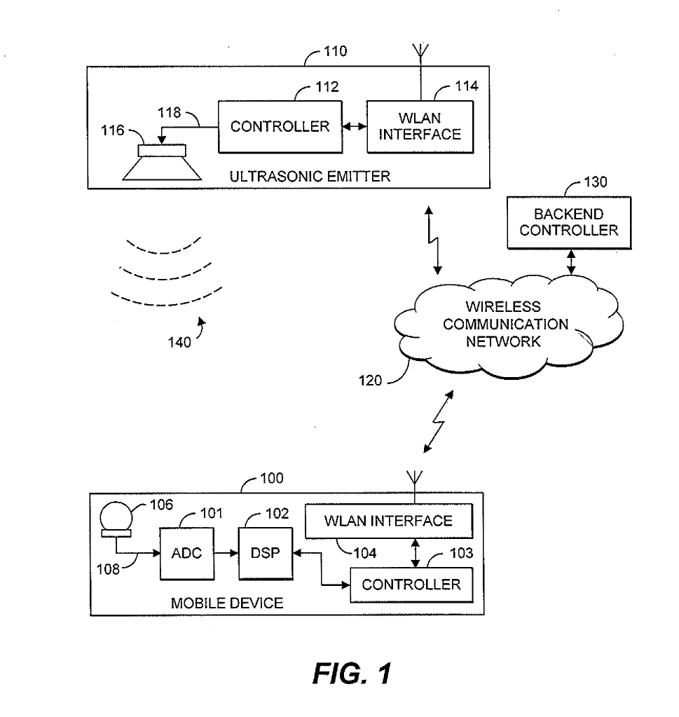

FIG. 1 is a block diagram of an ultrasonic aliasing and locationing system, in accordance with the present invention. One or more ultrasonic transponders such as a piezoelectric speaker or emitter 116 can be disposed within the environment. The emitter(s) can send a short burst of ultrasonic sound (e.g. 140) in the frequency range of about 20-22.05 kHz within the environment. The mobile device 100 can include audio circuitry and a digital signal processor 102 to process the ultrasonic signal 140. For example, the burst can be received from the emitter by a transponder such as a microphone 106, and the digital signal processor is used specifically to analyze the frequency and amplitude components of an audio signal resulting from intentional aliasing of a captured waveform of the burst 140 from the ultrasonic emitter 116, in accordance with the present invention. Intentional aliasing is done while the waveform is being captured. The circuit of the microphone 116 provides electrical signals 108 to receiver circuitry that can include an amplifier (not shown) and an analog-to-digital converter 101 that converts the ultrasonic burst into a digital waveform which is then passed to the digital signal processor 102. It is envisioned that the mobile device will have existing audio circuitry with available sampling frequencies as high as 44.1 kHz, i.e. the typically utilized Nyquist frequency for commercial audio devices, which relates to a 22.05 kHz usable upper frequency limit for processing audio signals. It is envisioned that waveform processing and analysis is implemented in the digital domain, in the digital signal processor 102. It should be recognized that other components, including amplifiers, digital filters, and the like, are known in the art and are not shown for the sake of simplicity of the drawings. For example, the microphone signals can be amplified in an audio amplifier and filtered using digital or analog filtering.

The digital signal processor 102 can also be coupled to a controller 103 and wireless local area network interface 104 for wireless communication with other devices in the communication network 120 such as a backend controller 130. The mobile device controller 103 or backend controller 130 can be used to provide a locationing engine to locate the mobile device within the environment utilizing characteristics of the burst, as will be detailed below. It is envisioned that a location of a mobile device can be determined in an environment with a two-dimensional positional accuracy of less than five feet with a reasonably economic spacing between ceiling devices of about fifty feet.

The wireless communication network 120 can include local and wide-area wireless networks, wired networks, or other IEEE 802.11 wireless communication systems, including virtual and extended virtual networks. However, it should be recognized that the present invention can also be applied to other wireless communication systems. For example, the description that follows can apply to one or more communication networks that are IEEE 802.xx-based, employing wireless technologies such as IEEE's 802.11, 802.16, or 802.20, modified to implement embodiments of the present invention. The protocols and messaging needed to establish such networks are known in the art and will not be presented here for the sake of brevity. The mobile device 100 also could be connected to the communication network 120 through a wired interface connection (not shown), such as an Ethernet interface connection.

The ultrasonic emitter(s) 110 can be a simple piezoelectric device hard-wired to emit a periodic ultrasonic burst 140 at one frequency. Optionally, the emitter(s) 110 can include a controller 112 that can change the timing and frequency of the ultrasonic signal 118 to be emitted. In the simplest example, the emitter is configured to have usable output across a 20-22.05 kHz frequency range and to repeat a single tone, from within that frequency range. The 20-22.05 kHz range has been chosen such that the existing audio circuitry of the mobile device will be able to detect the bursts without any users hearing the bursts in the environment.

In practice, a typical smart phone microphone frequency response is well over the 20 kHz that is usually quoted. This 20 kHz limit is mainly quoted since 20 kHz is the upper end of human hearing, as such, the highest frequency that needs to be considered ordinarily. In addition, manufacturers will state limits of the codec sampling frequency (i.e. Nyquist frequency) that are lumped into a system specification that does not consider the microphone alone. Further, the manufacturers list a codec amplifier response and DC blocking components in series with various stages. However, a few dB/per octave roll off still provides sufficient usable response up to 22 kHz. Therefore, the present invention utilizes this extra ultrasonic capacity of smart phone audio circuitry as described herein. In addition, it is envisioned that there is little audio noise in the range of 20-22 kHz to interfere with the ultrasonic bursts.

It is envisioned that the emitters are affixed to a ceiling of the indoor environment, with the emitters oriented to emit a downward burst towards a floor of the environment. Different emitters that are spatially dispersed within the environment can emit the same or different ultrasonic frequencies to enhance locationing by the mobile device. In the present invention, ultrasonic signals are typically provided from an emitter broadcasting a burst duration of a half-second or less.

The mobile device will utilize its existing audio processing circuitry to analyze the burst in the frequency domain, i.e. a Fast Fourier Transform (FFT). However, audio codecs are typically configured to sample incoming audio signals at a standard rate of 44.1 kHz. In order to introduce the intentional aliasing described herein, the present invention can program the audio codec to sample at a customizable frequency setting at a much lower frequency, e.g. 20-22.05 kHz. Aliasing is most often portrayed as an undesirable effect of too low of a sampling rate to properly construct a waveform with regard to the Nyquist frequency. Because of a limited available range of frequencies and a relatively small needed bandwidth, this invention relies on aliasing to help with the limited ultrasonic response of a typical smart phone.

In operation, the present invention sets an audio codec sampling frequency such that the digital waveform of the ultrasonic bursts are intentionally aliased into audio signals that are easier to analyze in the frequency domain than ultrasonic signals. In other words, it is much easier to analyze an audio signal than an ultrasonic signal. For example, a smart phone audio circuit can receive a 20.417 kHz burst from an emitter in the environment. The smart phone audio codec can be programmed to sample this 20.417 kHz burst using a 22.05 kHz sampling frequency, which results in the introduction of a 1.633 kHz (22.05 kHz-20.417 kHz) audio tone due to the aliasing of the burst frequency and the sampling frequency. The 1.633 kHz audio frequency requires much less FFT processing to analyze than the 20.417 kHz frequency, which result in faster digital signal processing. The capabilities for aliasing in the present invention depend on access to the raw data buffer of the smart phone and how the smart phone implements anti-alias filtering. This example chose 20.417 kHz to yield 1.633 kHz which is one of the standard DTMF frequencies which the next paragraph will show has additional advantages.

In the case where the smart phone is unable to program the sampling frequency of the smart phone, or where an anti-aliasing filter is hard-coded into the smart phone and cannot be disabled, then the standard 44.1 kHz audio codec frequency is used, which can be down converted to an equivalent 22.05 kHz sampling frequency by decimating every other sample. As used herein down sampling is done to the buffer after the waveform is captured. The concept of intentional aliasing can be applied to a buffer by down sampling for example when an anti-aliasing filter can't be disabled. In such a case, sampling at a high frequency like 44100 Hz, then down sampling at 22050 Hz will have the same effect as sampling at 22050 Hz but would eliminate the effects of the anti-aliasing filter. Further, if the raw data buffer of the smart phone cannot be accessed directly, than emitter burst frequencies are chosen that will result in aliased audio tones that match one of the existing standard Dual-Tone Multi-Frequency (DTMF) tones already recognizable by the smart phone. However, if the sampling frequency of the smart phone can be programmed and any anti-aliasing function of the smart phone can be disabled, than any suitable emitter frequency and audio codec sampling frequency can be used to introduce a desired audio signal.

The present invention has the critical advantage over dividing down at the buffer level that the frequency separation is not divided down at audio frequencies. This is important where signal frequencies can be Doppler shifted by a user moving around through the environment. Therefore, selected frequencies must be separated by a sufficient amount to provident overlapping of frequencies due to Doppler. Due to Doppler shifts that can occur with a mobile device, the amount of discernable frequency tones that can be accurately recognized within the available ultrasonic frequency range is limited. In the ultrasonic band of interest (20 kHz to 22.05 kHz), it is possible to distinguish a total of up to eight distinct tones while still leaving room for as much as +/−125 Hz of Doppler shift (more than enough margin to accommodate that which would be present from a very fast walking speed).

If it is assumed that there is only a few kHz of usable ultrasonic bandwidth, any ultrasonic signal that is divided down would also divide down the frequency separation. In other words, for the limiting DTMF scenario, using raw 20 KHz data divided down to the best case DTMF column tone of 1.633 KHz mandates a divisor of more than twelve, i.e. 20 KHz/12˜1.633 KHz. However, for the aliased audio tones with a bandwidth of 3 kHz, 3 kHz divided by 12 is only 250 Hz of separation which is less than any of the DTMF columns/row separations and therefore can permit the use of DTMF tones in the presence of Doppler shifts. In practice, 20.417 KHz sampled at a standard 22.05 KHz yields the highest DTMF column tone of 1.633 KHz, and values closer to 22.05 KHz yield all of the other lower DTMF tones. This has the advantage that standard DTMF applications supported by the various smart phone operating systems can be used without the need for custom audio drivers, i.e. the present invention can be implemented at the application level alone.

Once the audio signal is introduced in the smart phone by the intentional aliasing, the digital signal processor of the mobile device will use a Fast Fourier Transform (FFT). The FFT returns the frequencies and amplitudes of each signal present in the environment. Optionally, subtracting the known transmitted frequencies yields the Doppler frequency which indicates the component speed towards or away from the transmitter. The FFT allows the processor to discern a received signal strength indication (RSSI) of tones received from each emitter. The audio tones can easily be detected by the processor of the mobile device using a simple Goertzel algorithm or other FFT algorithm programmed to find frequency of interest. The frequency and RSSI of the discerned audio tones can then be used to locate the mobile device within the environment.

The mobile device 100 could determine its own location within the environment. This may necessitate receiving multiple ultrasonic bursts broadcast from different emitters spatially dispersed within the environment to provide multiple aliased audio signals. Locationing can be accomplished using a hyperbolic approach, triangulation, trilateration, and the like, as have been used in radio frequency locationing systems. Alternatively, the mobile device can transmit the audio tones it detects over the communication network 120 to a backend controller 130 that can determine the location of the mobile device based which audio tones it receives and a known floor plan of the emitter locations. It should be recognized that the particular tones of the ultrasonic emitter devices could be changed during operation. Choosing which tones to use can be coordinated by the backend controller 130 of the locationing system, which can communicate over the communication network 120 to direct each emitter 110 to emit the same specific tone periodically at the same or different periods.

Once the location information of a device is known, this location information can be used by the backend controller to supply specific information related to that location to the mobile device, such as information about products in that location, for example. In addition, the backend controller can push an interactive customer application to the mobile device relating to products in that location. Additional information such as the relative amplitude of the tones, the Doppler shift of the tones, and inertial navigation could be used to further improve the locationing accuracy or provide an optional motion vector for the mobile device.

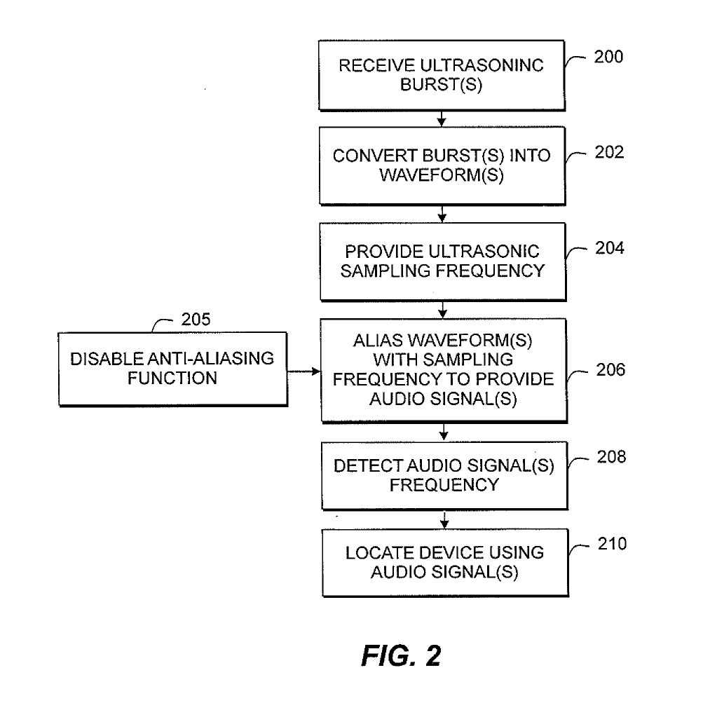

FIG. 2 is a diagram illustrating a method of intentional aliasing ultrasound to produce audio tones, according to some embodiments of the present invention. It is envisioned that the method utilizes existing audio circuitry hardware of the mobile device.

A first step 200 includes receiving an ultrasonic burst broadcast from an emitter in an environment by a mobile device. It is envisioned that the ultrasonic burst has a frequency between 20 kHz and 22.05 kHz.

A next step 202 includes converting the ultrasonic burst into a digital waveform.

A next step 204 includes providing an ultrasonic sampling frequency from the audio codec. It is envisioned that the audio codec has a customizable frequency setting between 20 kHz and 22.05 kHz. If the audio codec of the mobile device cannot be changed from a 44.1 kHz sample rate, then downsampling can be used to decimate this sample rate to 22.05 kHz.

A next step 206 includes aliasing the digital waveform with the ultrasonic sampling frequency to provide an audio signal. This step may require the disabling 205 of an anti-aliasing function of the mobile device. Aliasing can produce an audio signal of about 1.6 kHz or one of the Dual-Tone Multi-Frequency tones if the raw buffer of the waveform cannot be accessed.

A next step 208 includes detecting the audio signal frequency by the mobile device. This can include performing a Fast Fourier Transform on the audio signal to derive its frequency components and amplitude components that are used to establish a received signal strength of the ultrasonic burst for locationing purposes.

A next step 210 includes locationing the mobile device within the environment using the audio signals. This may necessitate receiving 200 multiple ultrasonic bursts broadcast from different emitters spatially dispersed within the environment to provide multiple aliased audio signals. Locationing can be accomplished using hyperbolic positioning, triangulation, trilateration, and the like, as have been used in radio frequency locationing systems.

An additional locationing technique of the present invention uses a determination of Doppler frequency of the aliased ultrasonic signal, received by the smart phone, from more than one emitter (if available), which relates to speed towards or away from each emitter. This is determined by the exact distance in the raw data buffer between the peaks and valleys of the aliases waveform to get the received frequency and subtracting the known stationary frequency. The speeds towards or away from three or more emitters yields the mobile device's location using an intersection of hyperbolas. Three emitters would allow locationing in two-dimensions, while four emitters would allow three-dimensional locationing.

With Doppler information alone, deriving locationing equations can be difficult using a hyperbolic approach because each possible position has a direction associated with it. If the direction was known, hyperbolic equations could be used but the number of cases quickly complicates things. Even if all cases are considered, searching complex models has downsides of CPU time and the possibility of settling on a local minimum.

An easier approach is to build a solution based on the availability of one or more known radii between the emitters and the mobile device. Understanding cases when radii information is available makes the case when no radii information is available easier to derive. Different ways to reduce the required number of transmitters that are “in view” are presented, called Reduction 1 and Reduction 2 herein.

The following solution generally does not need a known initial position but cases are discussed where a known position reduces the required number of “in view” emitters. Only a two-dimensional solution is given where the smart phone height is assumed to be four-feet above the floor (i.e. Reduction 1). This reduces complexity and reduces the required number of “in view” emitters. The count of “in view” transmitters will vary as the smart phone is moved around the environment, and it is assumed that there will be times when less than three emitters will be “in view”.

If the emitters are disposed on the ceiling and the smart phone is assumed to be four-feet above the floor, a solution is provided involving two parallel planes with a known distance between them, which is nothing more than taking the three-dimensional components and applying the sum of the squares to convert to two-dimensions. This solution does not introduce any computational complexity or CPU overhead.

Radius cases are primarily given herein as a way to approach the problem. If one or more flight times (radii) are available, which can be demonstrated on a smart phone, accuracy will benefit with minimum “in view” emitters. In particular, the establishment of actual flight times of the ultrasonic burst from an emitter to one or more microphones can augment the locationing algorithm to improve accuracy.

In a first three-dimensional case, three radius inputs with no Doppler inputs are needed. This is basic trilateration where the intersection of three spheres determines a single point in three-dimensional space.

In a second two and three-dimensional case three radius inputs with no Doppler inputs are needed. In three-dimensions, the intersection of two spheres cut by a plane yields two points. For a plane four-feet above the floor, it is clear that there are two intersection points. In two-dimensions, the intersection of two circles yields two points. An additional input is needed to resolve the ambiguity between the two points (i.e. Reduction 2). Another way would be two exclude one of the two points based on a comparison with future (or past) ambiguous point sets. It is likely that within a few samples, considering other radius case modes that would be entered, the ambiguity will be resolved i.e. one of the two points can be removed from consideration. Between previously known locations, it should be apparent than one of two points can be excluded in short order, given the fact that users can't walk into objects on the planogram, and considering radius case mode changes and orientation information. The only difference is that the logic to select the correct point is a bit less straight forward.

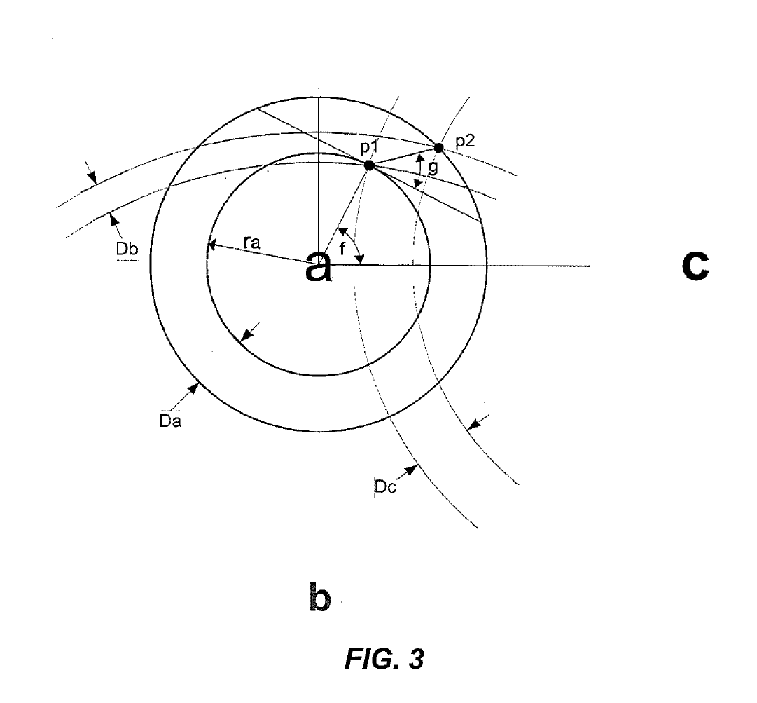

Referring to FIG. 3, in a third two-dimensional, one radius input and three Doppler inputs are needed. Points a, b and c represent known emitter locations. Da, Db and Dc are the Doppler amplitudes received from each emitter. ra is the distance between the smart phone and emitter a. The solution to this case searches possible values of angles f and g. Picking an arbitrary required resolution of 1 degree, the search will take at most 360 outer loop iterations of f and 180 inner iterations of g. This is only 64,800 iterations each with a handful directly solvable assignment statements. This is a trivial amount of processing for a modern day CPU.

The inner loop procedure for this process begins by calculating the position of p1 based on the angle f, the position of a, and the value of ra. The calculation of position of p2 is based on the position of p1, the slope of line p1 to p2 (e.g. for case shown, simply f+g−90), and the intersection of line p1 to p2 with circle a of radius ra+Da. The procedure then calculates distances from p1 and p2 to b and c (all known locations). Subtract each distance pair for b and c to get test values Dbt, Dct (distance related to Doppler by wavelength and period that the Doppler measurement was taken).

Determining the best error starts by initialized outside loops to some large value: test=abs(Dbt−Db)+abs(Dct−Dc). If test<best error, then the best error is set to the test value and the answer is p2.

In a fourth two-dimensional case, no radius inputs and four Doppler inputs are needed. The solution to this case is to search possible Ra values from the third case above and test against the measured Doppler value from the fourth emitter d. The test will pass at two points, one of which will have to be excluded using Reduction 2 reasoning.

In a fifth two-dimensional case, an initial position and two Doppler inputs are needed. Here the new position is just the old position moved by the components toward/away from the two emitters. This case works well if the smart phone is near a low power RF device at a known location. However, this case is subject to drift.

In other cases an accelerometer/gyroscope/magnetometer can be used for locationing. For example, knowing the speed of the smart phone or the change in speed during the period that the Doppler measurement was made might reduce the required number of “in view” emitters or increase accuracy or search time. Similarly, knowing the direction of the motion of the smart phone can reduce the required number of “in view” emitters or increase accuracy or search time.

Advantageously, the present invention provides an ultrasonic locationing system using a receiver running an audio codec, and audio microphone, and a digital signal processor, all of which are present in nearly every smart phone that is manufactured today. The present invention can be implemented using this existing hardware and a software application which could be downloaded and installed to use the existing hardware in the novel way described herein. The processing power to identify the frequency tone is minimal

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors or processing devices such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a compact disc Read Only Memory, an optical storage device, a magnetic storage device, a Read Only Memory, a Programmable Read Only Memory, an Erasable Programmable Read Only Memory, an Electrically Erasable Programmable Read Only Memory, and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A mobile device providing intentional aliasing of ultrasound to produce audio tones, the method comprising the steps of:
a microphone circuit operable to receive an ultrasonic burst broadcast from at least one emitter in an environment;
an analog-to-digital converter coupled to microphone circuit and the operable to convert the ultrasonic burst into a digital waveform; and
a digital signal processor coupled to the analog-to-digital converter and operable to:
provide an ultrasonic sampling frequency,
alias the digital waveform with the ultrasonic sampling frequency to provide an audio signal, and
detect the audio signal frequency.

2. The device of claim 1, wherein the digital signal processor is also operable to perform a Fast Fourier Transform on the audio signal.

3. The device of claim 1, wherein the digital signal processor is also operable to determine an amplitude of the audio signal to establish a received signal strength of the ultrasonic burst.

4. The device of claim 1, wherein the ultrasonic burst and the sampling frequency have a frequency between 20 kHz and 22.05 kHz, and the mobile device utilizes existing audio circuitry.

5. The device of claim 1, wherein the audio signal is one of a Dual-Tone Multi-Frequency tone.

6. The device of claim 1, further comprising an anti-aliasing function of the mobile device operable to be disabled.

7. The device of claim 1, wherein the digital signal processor is also operable to sample the ultrasonic burst at 44.1 kHz and downsample this sample to 22.05 kHz.

8. The device of claim 1, wherein the microphone circuit is operable to receive multiple ultrasonic bursts broadcast from different emitters spatially dispersed within the environment to provide multiple aliased audio signals.

9. The device of claim 8, further comprising a controller coupled to the digital signal processor and operable to locate the mobile device within the environment using the audio signals.

10. The device of claim 9, wherein controller is operable to augment locationing with at least one Doppler measurement of the multiple ultrasonic burst from the different emitters.

11. A mobile device providing intentional aliasing of ultrasound to produce audio tones, the device comprising:
a microphone circuit operable to receive an ultrasonic burst broadcast from multiple emitters spatially dispersed within an environment;
an analog-to-digital converter coupled to the microphone circuit and operable to convert the ultrasonic bursts into digital waveforms;
a digital signal processor coupled to the analog-to-digital converter and operable to:
provide an ultrasonic sampling frequency,
alias the digital waveforms with the ultrasonic sampling frequency to provide audio signals, and
detect frequencies and amplitudes of the audio signals; and
a controller coupled to the digital signal processor and operable to locate the mobile device using the audio signals.

12. A method of intentionally aliasing ultrasound to produce audio tones, the method comprising the steps of:
receiving an ultrasonic burst broadcast from an emitter in an environment by a mobile device;
converting the ultrasonic burst into a digital waveform;
providing an ultrasonic sampling frequency;
aliasing the digital waveform with the ultrasonic sampling frequency to provide an audio signal; and
detecting the audio signal frequency by the mobile device.

13. The method of claim 12, wherein detecting includes performing a Fast Fourier Transform on the audio signal.

14. The method of claim 12, wherein detecting includes determining an amplitude of the audio signal to establish a received signal strength of the ultrasonic burst.

15. The method of claim 12, wherein the ultrasonic burst in the receiving step and the sampling frequency in the providing step have a frequency between 20 kHz and 22.05 kHz, and the mobile device utilizes existing audio circuitry for the method steps.

16. The method of claim 12, wherein the audio signal is one of a Dual-Tone Multi-Frequency tone.

17. The method of claim 12, further comprising the step of disabling an anti-aliasing function of the mobile device.

18. The method of claim 12, wherein converting includes sampling the ultrasonic burst at 44.1 kHz and downsampling this sample to 22.05 kHz.

19. The method of claim 12, wherein receiving include receiving multiple ultrasonic bursts broadcast from different emitters spatially dispersed within the environment to provide multiple aliased audio signals.

20. The method of claim 19, further comprising the step of locationing the mobile device within the environment using the audio signals.
